(19) United States
(12) Patent Application Publication
(10) Pub. No.: US 2018/0123673 A1
(43) Pub. Date: May 3, 2018

(54) MULTI-SUBCARRIER BASED RADIO FRAME TRANSMISSION METHOD AND COMMUNICATION NODE THEREFOR

(71) Applicant: ELECTRONICS AND TELECOMMUNICATIONS RESEARCH INSTITUTE, Daejeon (KR)

(72) Inventors: Seok Ki KIM, Daejeon (KR); Seung Kwon BAEK, Daejeon (KR)

(73) Assignee: ELECTRONICS AND TELECOMMUNICATIONS RESEARCH INSTITUTE, Daejeon (KR)

(21) Appl. No.: 15/800,060

(22) Filed: Oct. 31, 2017

(30) Foreign Application Priority Data
Nov. 1, 2016 (KR) 10-2016-0144787
Oct. 19, 2017 (KR) 10-2017-0135626

(51) Int. Cl. H04B 7/06; H04B 7/08

(52) U.S. Cl. CPC H04B 7/0682; H04L 2027/0095; H04B 7/086

(57) ABSTRACT

A multi-subcarrier based radio frame transmission method of a communication node in a mobile communication system may comprise configuring at least one beam sweeping region for beam sweeping in a plurality of subframes constituting a radio frame; arranging a broadcast channel (BCH) or a feedback channel (FBCH) together with a plurality of preambles (PAs) in the at least one beam sweeping region; and transmitting the radio frame in which the at least one beam sweeping region is configured.

### CROSS-REFERENCE TO RELATED APPLICATIONS

This application claims priorities to Korean Patent Applications No. 10-2016-0144787 filed on Nov. 1, 2016, and No. 10-2017-0135626 filed on Oct. 19, 2017 in the Korean Intellectual Property Office (KIPO), the entire contents of which are hereby incorporated by reference.

### BACKGROUND

### 1. Technical Field

The present disclosure relates to a radio frame transmission method, and more specifically, to a multi-subcarrier based radio frame transmission method for transmitting multiple subcarriers having various formats through a radio frame having a unified format, and a communication node therefor.

### 2. Related Art

Multi-subcarrier radio frame may be composed of a plurality of subframes in a time domain, and each of the plurality of subframes may have a plurality of slots each of which has a plurality of symbols. Also, the symbol may be composed of a plurality of resource blocks (RBs) in a frequency domain, and a RB may be composed of a plurality of subcarriers.

For a communication node (i.e., a terminal), a communication link for transmission (Tx) may be defined as a forward link (FL) or downlink (DL), and a communication link for reception (Rx) may be defined as a reverse link (RL) or uplink (UL). Separate radio resources may be used for the UL and the DL. A transmission and reception duplexing is an operation to support both the UL and the DL. For example, a frequency division duplex (FDD), a time division duplex (TDD), or a hybrid division duplex (HDD) is generally used for the transmission and reception duplexing. In the case of the FDD, a guard band (GB) is required between transmission and reception frequencies. In the case of the TDD, a guard period (GP) is required between transmission and reception times.

A beam is a signal that is spatially filtered through beamforming. Through the beamforming, the throughput of the communication system can be enhanced by increasing the receive power and the efficiency of the radio resources. When beam directions of beam-formed and transmitted reference signals, synchronization channels, broadcast channels, data channels, etc. are overlapped with each other in neighboring base stations, error of channel state information measured from the reference signal becomes larger, and the probability of failure in decoding the synchronization channels and the broadcast channels may be increased. Accordingly, a beam sweeping scheme has been proposed in which beams between base stations should not overlap with each other, and all the beams that can be formed are alternately transmitted.

A conventional multi-subcarrier based radio frame considers a bandwidth of about several tens of megahertz (MHz) in a frequency band of 6 GHz or less and a radio transmission using a small number of antennas, and there are also many restrictions in beamforming techniques to be used. Also, although various types of radio frame structures are required according to the transmission and reception duplexing, only a fixed subcarrier based radio transmission scheme is currently supported.

In the 5G mobile communication system, a broadband radio transmission using a millimeter wave (mmWave) band of 6 GHz or more and a beamforming technique using a massive antenna are being considered. Also, various transmission and reception duplexing schemes and various multi-subcarrier based radio transmission schemes are being considered. Therefore, a new type of radio frame structure and a transmission method for radio transmission of the 5G mobile communication system are required.

### SUMMARY

Accordingly, embodiments of the present disclosure provide a method of transmitting radio frames for radio transmission of the 5G mobile communication system, and a communication node therefor.

Accordingly, embodiments of the present disclosure also provide a method of transmitting radio frames, which is suitable for broadband wireless transmissions and beamforming techniques using massive antenna, and a communication node therefor.

Accordingly, embodiments of the present disclosure also provide a method of transmitting radio frames, which supports various transmission and reception duplexing schemes, and a communication node therefor.

Accordingly, embodiments of the present disclosure also provide a method of transmitting radio frames, which supports various types of multi-subcarrier based wireless transmission schemes, and a communication node therefor.

Accordingly, embodiments of the present disclosure also provide a method of transmitting radio frames of unified format, which supports radio transmissions in various networks, and a communication node therefor.

Accordingly, embodiments of the present disclosure also provide a method of transmitting radio frames, which supports beam sweeping operations and initial access operations based on beam sweeping, and a communication node therefor.

In order to achieve the objective of the present disclosure, a multi-subcarrier based radio frame transmission method of a communication node in a mobile communication system may comprise configuring at least one beam sweeping region for beam sweeping in a plurality of subframes constituting a radio frame; arranging a broadcast channel (BCH) or a feedback channel (FBCH) together with a plurality of preambles (PAs) in the at least one beam sweeping region; and transmitting the radio frame in which the at least one beam sweeping region is configured.

In the transmitting, the BCH or the FBCH may be transmitted together with the plurality of PAs through a plurality of beams in a time division multiplexing (TDM) scheme by grouping the plurality of beams.

In the transmitting, the BCH or the FBCH may be transmitted together with the plurality of PAs through a same beam in a time division multiplexing (TDM) scheme by grouping the BCH or the FBCH together with the plurality of PAs.

In the transmitting, the BCH or the FBCH may be transmitted together with the plurality of PAs by using different frequency bands in a frequency division multiplexing (FDM) scheme, transmitted together with the plurality of PAs by using a first beam at a first time, and transmitted together with the plurality of PAs by using a second beam at a second time.

At least one of the plurality of PAs may include at least one beam index for identifying a plurality of beams for the beam sweeping.

Each of the plurality of subframes may include a plurality of slots, and the plurality of slots are 2ⁿ slots, 2×2ⁿ slots, or 7×2ⁿ slots wherein n is a natural number. Also, each of the 2ⁿ slots may include 14 symbols, each of the 2×2ⁿ slots may include 7 symbols, or each of the 7×2ⁿ slots may include 2 symbols. Also, one of the plurality of slots may include a control region, a data region, a demodulation reference signal (DM-RS) region, and a channel state information reference signal (CSI-RS) region, and the one of the plurality of slots may be arranged in a forward link slot interval or a reverse link slot interval. Also, a first guard interval, a second guard interval shorter than the first guard interval, or no guard interval may be arranged between the forward link slot interval and the reverse link slot interval.

When the second guard interval shorter than the first guard interval, or no guard interval is arranged between the forward link slot interval and the reverse link slot interval, a transmission start time of the reverse link slot interval may be advanced by a time corresponding to a round trip delay (RTD).

In order to achieve the objective of the present disclosure, a communication node in a mobile communication system, for transmitting a multi-subcarrier based radio frame, may comprise a processor, a memory storing at least one instruction executed by the processor, and a transceiver performing communications as connected to the mobile communication system. Also, the at least one instruction may be configured to configure at least one beam sweeping region for beam sweeping in a plurality of subframes constituting a radio frame; arrange a broadcast channel (BCH) or a feedback channel (FBCH) together with a plurality of preambles (PAs) in the at least one beam sweeping region; and transmit the radio frame in which the at least one beam sweeping region is configured.

The at least one instruction may be further configured to transmit the BCH or the FBCH together with the plurality of PAs through a plurality of beams in a time division multiplexing (TDM) scheme by grouping the plurality of beams.

The at least one instruction may be further configured to transmit the BCH or the FBCH together with the plurality of PAs through a same beam in a time division multiplexing (TDM) scheme by grouping the BCH or the FBCH together with the plurality of PAs.

The at least one instruction may be further configured to transmit the BCH or the FBCH together with the plurality of PAs by using different frequency bands in a frequency division multiplexing (FDM) scheme, transmit the BCH or the FBCH together with the plurality of PAs by using a first beam at a first time, and transmit the BCH or the FBCH together with the plurality of PAs by using a second beam at a second time.

At least one of the plurality of PAs may include at least one beam index for identifying a plurality of beams for the beam sweeping.

Each of the plurality of subframes may include a plurality of slots, and the plurality of slots are 2ⁿ slots, 2×2ⁿ slots, or 7×2ⁿ slots wherein n is a natural number. Also, each of the 2ⁿ slots may include 14 symbols, each of the 2×2ⁿ slots may include 7 symbols, or each of the 7×2ⁿ slots may include 2 symbols. Also, one of the plurality of slots may include a control region, a data region, a demodulation reference signal (DM-RS) region, and a channel state information reference signal (CSI-RS) region, and the one of the plurality of slots may be arranged in a forward link slot interval or a reverse link slot interval. Also, a first guard interval, a second guard interval shorter than the first guard interval, or no guard interval may be arranged between the forward link slot interval and the reverse link slot interval.

When the second guard interval shorter than the first guard interval, or no guard interval is arranged between the forward link slot interval and the reverse link slot interval, a transmission start time of the reverse link slot interval may be advanced by a time corresponding to a round trip delay (RTD).

According to the embodiments of the present disclosure, provided are a method of transmitting radio frames for radio transmission of the 5G mobile communication system, and a communication node therefor.

According to the embodiments of the present disclosure, provided are a method of transmitting radio frames, which is suitable for broadband wireless transmissions and beamforming techniques using massive antenna, and a communication node therefor.

According to the embodiments of the present disclosure, provided are a method of transmitting radio frames, which supports various transmission and reception duplexing schemes, and a communication node therefor.

According to the embodiments of the present disclosure, provided are a method of transmitting radio frames, which supports various types of multi-subcarrier based wireless transmission schemes, and a communication node therefor.

According to the embodiments of the present disclosure, provided are a method of transmitting radio frames of unified format, which supports radio transmissions in various networks, and a communication node therefor.

According to the embodiments of the present disclosure, provided are a method of transmitting radio frames, which supports beam sweeping operations and initial access operations based on beam sweeping, and a communication node therefor.

According to the embodiments of the present disclosure, overhead due to the beam sweeping in the initial access operations can be reduced, and performance of beam searching can be enhanced. Also, overhead of guard periods due to transmission and reception mode switching in a frame structure to which the TDD scheme is applied can be reduced.

### BRIEF DESCRIPTION OF DRAWINGS

Embodiments of the present disclosure will become more apparent by describing in detail embodiments of the present disclosure with reference to the accompanying drawings, in which:

FIG. 1 is a conceptual diagram illustrating a first embodiment of a communication system;

FIG. 2 is a block diagram illustrating a first embodiment of a communication node constituting a communication system;

FIG. 3 is a diagram illustrating a multiple-subcarrier based radio frame according to an embodiment of the present disclosure;

FIG. 4 is a diagram illustrating a transmission scheme of a sweeping region according to a transmission/reception duplexing scheme;

FIG. 5 is a diagram illustrating a method of transmitting a preamble, a broadcast channel, and a feedback channel in a beam sweeping region by applying time division multiplexing and a beam grouping scheme;

FIG. 6 is a diagram illustrating a method of transmitting a preamble, a broadcast channel, and a feedback channel in a beam sweeping region by applying time division multiplexing and an information grouping scheme;

FIG. 7 is a diagram illustrating a method of transmitting a preamble, a broadcast channel, and a feedback channel in a beam sweeping region by applying frequency division multiplexing;

FIG. 8 is a diagram illustrating an example of a method of transmitting two preambles and one broadcast channel or feedback channel;

FIG. 9 is a diagram illustrating another example of a method of transmitting two preambles and one broadcast channel or feedback channel;

FIG. 10 is a diagram illustrating another example of a method of transmitting three preambles and one broadcast channel or feedback channel;

FIG. 11 is a diagram illustrating yet another example of a method of transmitting two preambles and one broadcast channel or feedback channel;

FIG. 12 is a diagram illustrating another example of a method of transmitting three preambles and one broadcast channel or feedback channel;

FIG. 13 is a diagram illustrating a structure of a slot included in a radio frame according to an example of the present disclosure;

FIGS. 14A to 14D are diagrams illustrating DL slot intervals and UL slot intervals according to duplexing schemes;

FIG. 15 is a diagram for explaining a first operation mode in case that insertion of a GP is omitted or a GP having a short length is inserted;

FIG. 16 is a diagram for explaining a second operation mode in case that insertion of a GP is omitted or a GP having a short length is inserted; and

FIG. 17 is a flow chart for explaining an example of a method of transmitting a multi-subcarrier based radio frame according to an embodiment of the present disclosure.

### DETAILED DESCRIPTION

Embodiments of the present disclosure are disclosed herein. However, specific structural and functional details disclosed herein are merely representative for purposes of describing embodiments of the present disclosure, however, embodiments of the present disclosure may be embodied in many alternate forms and should not be construed as limited to embodiments of the present disclosure set forth herein.

Accordingly, while the present disclosure is susceptible to various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, embodiments of the present disclosure will be described in greater detail with reference to the accompanying drawings. In order to facilitate general understanding in describing the present disclosure, the same components in the drawings are denoted with the same reference signs, and repeated description thereof will be omitted.

Hereinafter, wireless communication networks to which exemplary embodiments according to the present disclosure will be described. However, wireless communication networks to which exemplary embodiments according to the present disclosure are applied are not restricted to what will be described below. That is, exemplary embodiments according to the present disclosure may be applied to various wireless communication networks.

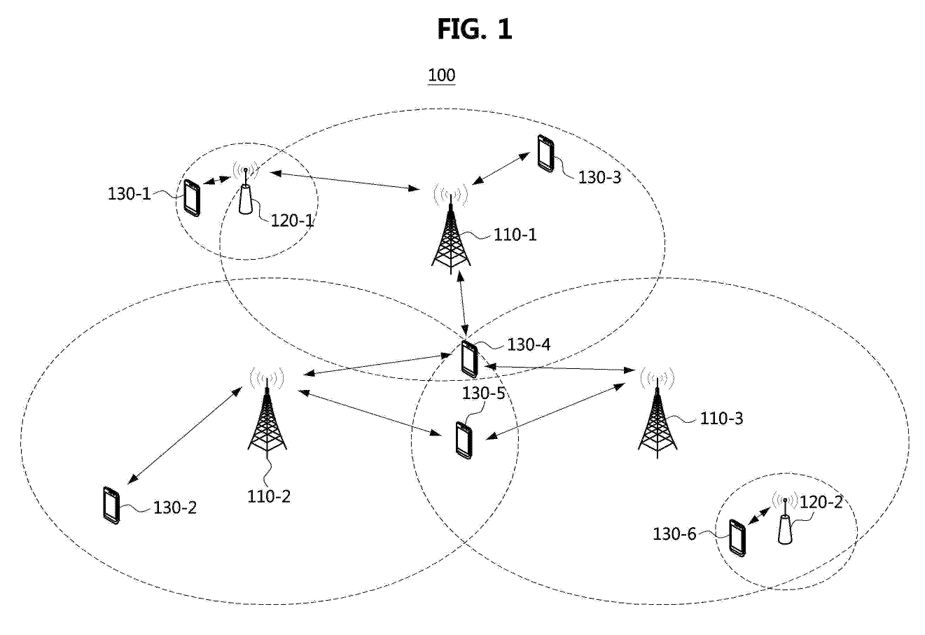

FIG. 1 is a conceptual diagram illustrating a first embodiment of a communication system.

Referring to FIG. 1, a communication system 100 may comprise a plurality of communication nodes 110-1, 110-2, 110-3, 120-1, 120-2, 130-1, 130-2, 130-3, 130-4, 130-5, and 130-6. Also, the communication system 100 may also be referred to as a ‘communication network’, and may comprise a core network (e.g., a serving gateway (S-GW), a packet data network (PDN) gateway (P-GW), a mobility management entity (MME), and the like).

The plurality of communication nodes may support 4^{th} generation (4G) communication (e.g., long term evolution (LTE), LTE-advanced (LTE-A)), or 5^{th} generation (5G) communication defined in the 3^{rd} generation partnership project (3GPP) standard. The 4G communication may be performed in a frequency band below 6 gigahertz (GHz), and the 5G communication may be performed in a frequency band above 6 GHz. For example, for the 4G and 5G communications, the plurality of communication nodes may support at least one communication protocol among a code division multiple access (CDMA) based communication protocol, a wideband CDMA (WCDMA) based communication protocol, a time division multiple access (TDMA) based communication protocol, a frequency division multiple access (FDMA) based communication protocol, an orthogonal frequency division multiplexing (OFDM) based communication protocol, an orthogonal frequency division multiple access (OFDMA) based communication protocol, a single carrier FDMA (SC-FDMA) based communication protocol, a non-orthogonal multiple access (NOMA) based communication protocol, and a space division multiple access (SDMA) based communication protocol. Also, each of the plurality of communication nodes may have the following structure.

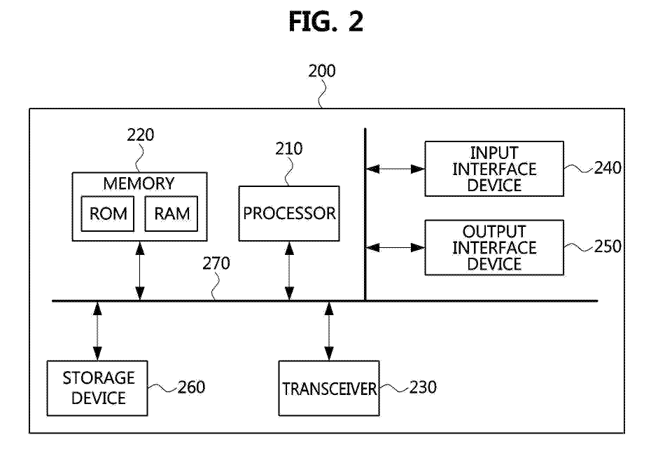

FIG. 2 is a block diagram illustrating a first embodiment of a communication node constituting a communication system.

Referring to FIG. 2, a communication node 200 may comprise at least one processor 210, a memory 220, and a transceiver 230 connected to the network for performing communications. Also, the communication node 200 may further comprise an input interface device 240, an output interface device 250, a storage device 260, and the like. Each component included in the communication node 200 may communicate with each other as connected through a bus 270.

The processor 210 may execute a program stored in at least one of the memory 220 and the storage device 260. The processor 210 may refer to a central processing unit (CPU), a graphics processing unit (GPU), or a dedicated processor on which methods in accordance with embodiments of the present disclosure are performed. Each of the memory 220 and the storage device 260 may be constituted by at least one of a volatile storage medium and a non-volatile storage medium. For example, the memory 220 may comprise at least one of read-only memory (ROM) and random access memory (RAM).

Referring again to FIG. 1, the communication system 100 may comprise a plurality of base stations 110-1, 110-2, 110-3, 120-1, and 120-2, and a plurality of terminals 130-1, 130-2, 130-3, 130-4, 130-5, and 130-6. Each of the first base station 110-1, the second base station 110-2, and the third base station 110-3 may form a macro cell, and each of the fourth base station 120-1 and the fifth base station 120-2 may form a small cell. The fourth base station 120-1, the third terminal 130-3, and the fourth terminal 130-4 may belong to cell coverage of the first base station 110-1. Also, the second terminal 130-2, the fourth terminal 130-4, and the fifth terminal 130-5 may belong to cell coverage of the second base station 110-2. Also, the fifth base station 120-2, the fourth terminal 130-4, the fifth terminal 130-5, and the sixth terminal 130-6 may belong to cell coverage of the third base station 110-3. Also, the first terminal 130-1 may belong to cell coverage of the fourth base station 120-1, and the sixth terminal 130-6 may belong to cell coverage of the fifth base station 120-2.

Here, each of the plurality of base stations 110-1, 110-2, 110-3, 120-1, and 120-2 may refer to a Node-B, a evolved Node-B (eNB), a base transceiver station (BTS), a radio base station, a radio transceiver, an access point, an access node, or the like. Also, each of the plurality of terminals 130-1, 130-2, 130-3, 130-4, 130-5, and 130-6 may refer to a user equipment (UE), a terminal, an access terminal, a mobile terminal, a station, a subscriber station, a mobile station, a portable subscriber station, a node, a device, or the like.

Each of the plurality of communication nodes 110-1, 110-2, 110-3, 120-1, 120-2, 130-1, 130-2, 130-3, 130-4, 130-5, and 130-6 may support cellular communications (e.g., the LTE or the LTE-advanced (LTE-A) defined in the 3GPP). Each of the plurality of base stations 110-1, 110-2, 110-3, 120-1, and 120-2 may operate in the same frequency band or in different frequency bands. The plurality of base stations 110-1, 110-2, 110-3, 120-1, and 120-2 may be connected to each other via an ideal backhaul or a non-ideal backhaul, and exchange information with each other via the ideal or non-ideal backhaul. Also, each of the plurality of base stations 110-1, 110-2, 110-3, 120-1, and 120-2 may be connected to the core network through the ideal or non-ideal backhaul. Each of the plurality of base stations 110-1, 110-2, 110-3, 120-1, and 120-2 may transmit a signal received from the core network to the corresponding terminal 130-1, 130-2, 130-3, 130-4, 130-5, or 130-6, and transmit a signal received from the corresponding terminal 130-1, 130-2, 130-3, 130-4, 130-5, or 130-6 to the core network.

Each of the plurality of base stations 110-1, 110-2, 110-3, 120-1, and 120-2 may support OFDMA based downlink (forward link) transmissions, and SC-FDMA based uplink (reverse link) transmissions. Also, each of the plurality of base stations 110-1, 110-2, 110-3, 120-1, and 120-2 may support a multi-input multi-output (MIMO) transmission (e.g., a single-user MIMO (SU-MIMO), a multi-user MIMO (MU-MIMO), a massive MIMO, or the like), a coordinated multipoint (CoMP) transmission, a carrier aggregation (CA) transmission, a transmission in unlicensed band, a device-to-device (D2D) communications (or, proximity services (ProSe)), or the like. Here, each of the plurality of terminals 130-1, 130-2, 130-3, 130-4, 130-5, and 130-6 may perform operations corresponding to the operations of the plurality of base stations 110-1, 110-2, 110-3, 120-1, and 120-2 (i.e., the operations supported by the plurality of base stations 110-1, 110-2, 110-3, 120-1, and 120-2). For example, the second base station 110-2 may transmit a signal to the fourth terminal 130-4 in the SU-MIMO manner, and the fourth terminal 130-4 may receive the signal from the second base station 110-2 in the SU-MIMO manner. Alternatively, the second base station 110-2 may transmit a signal to the fourth terminal 130-4 and fifth terminal 130-5 in the MU-MIMO manner, and the fourth terminal 130-4 and fifth terminal 130-5 may receive the signal from the second base station 110-2 in the MU-MIMO manner.

The first base station 110-1, the second base station 110-2, and the third base station 110-3 may transmit a signal to the fourth terminal 130-4 in the CoMP transmission manner, and the fourth terminal 130-4 may receive the signal from the first base station 110-1, the second base station 110-2, and the third base station 110-3 in the CoMP manner. Also, each of the plurality of base stations 110-1, 110-2, 110-3, 120-1, and 120-2 may exchange signals with the corresponding terminals 130-1, 130-2, 130-3, 130-4, 130-5, or 130-6 which belongs to its cell coverage in the CA manner. Each of the base stations 110-1, 110-2, and 110-3 may control D2D communications between the fourth terminal 130-4 and the fifth terminal 130-5, and thus the fourth terminal 130-4 and the fifth terminal 130-5 may perform the D2D communications under control of the second base station 110-2 and the third base station 110-3.

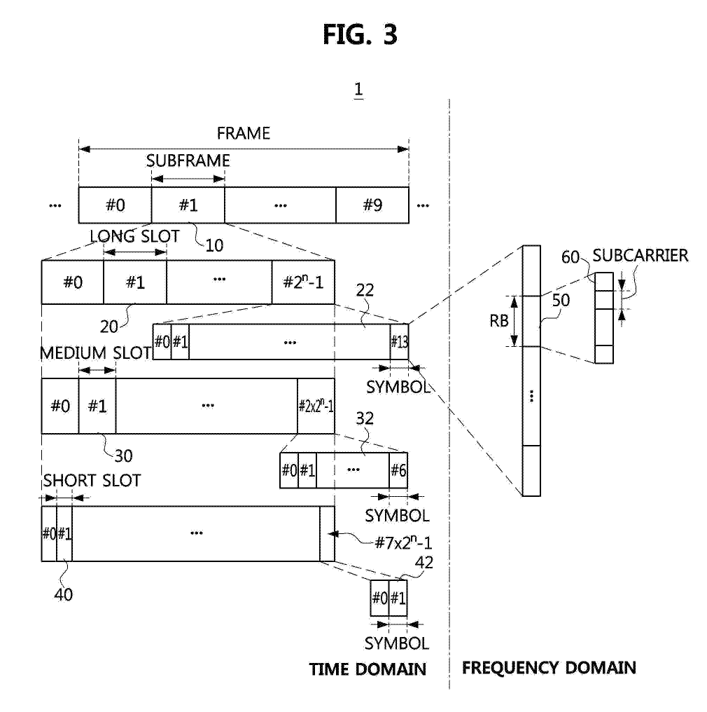

FIG. 3 is a diagram illustrating a multiple-subcarrier based radio frame according to an embodiment of the present disclosure.

Referring to FIG. 3, a radio frame 1 according to an embodiment of the present disclosure may include a time domain and a frequency domain, and a communication node may transmit and receive data to and from another communication node using the radio frame 1. The radio frame 1 may include a plurality of subframes 10 (e.g., 10 subframes) in the time domain. Each of the plurality of subframes 10 may include 2ⁿ long slots 20 (n is a natural number), 2×2ⁿ medium slots, or 7×2ⁿ short slots 40.

In case that the subframe 10 includes 2ⁿ long slots 20, each of the long slots 20 may comprise a plurality of symbols 22 (e.g., 14 symbols). In case that the subframe 10 includes 2×2ⁿ medium slots 30, each medium slot 30 may include a plurality of symbols 32 (e.g., 7 symbols). In case that the subframe 10 includes 7×2ⁿ short slots 40, each of the short slots 40 may include a plurality of symbols 42 (e.g., 2 symbols). The symbol 22 constituting the long slot 20 in the time domain, the symbol 32 constituting the medium slot 30, and the symbol 42 constituting the short slot 40 may have the same length.

Each of the symbols 22, 32 and 42 may include f(n)×M (M is a natural number) resource blocks (RBs) 50 in the frequency domain. Each of the plurality of RBs 50 may include a plurality of subcarriers 60. Here, n may be one of 0, 1, 2, 3, 4, and 5, and may be a value obtained by dividing subcarrier spacing (SCS) expressed in hertz (Hz) units by 15 kHz and taking its logarithm of 2. Also, in case that n is 0, 1, or 2, f (n) may be 50. Also, in case that n is 3, 4, or 5, f (n) may be 32. M may be 1, 2, . . . , or 10. Here, M may be selected such that 15 kHz×2ⁿ×12×f(n)×M is less than or equal to an operating frequency bandwidth of the communication node expressed in Hz. In the present disclosure, a frame may mean a radio frame 1 or a subframe 10.

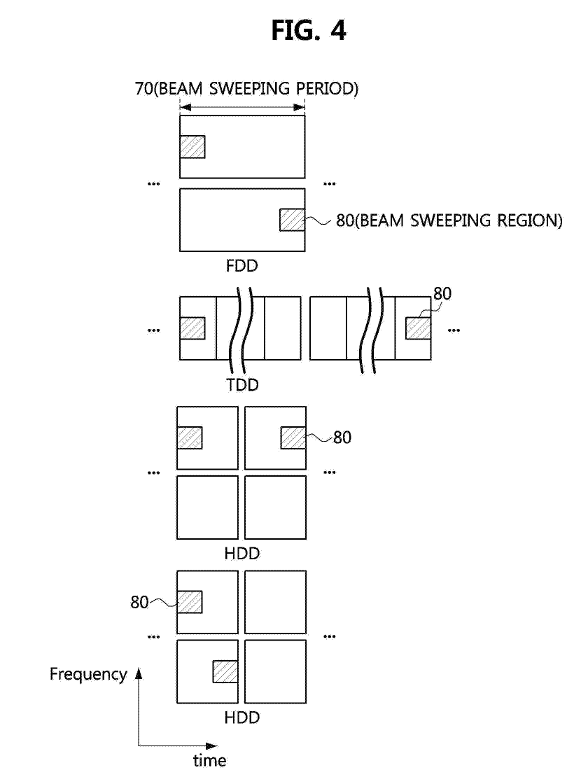

FIG. 4 is a diagram illustrating a transmission scheme of a sweeping region according to a transmission/reception duplexing scheme. Referring to FIG. 4, a communication node may transmit a multi-subcarrier based radio frame 1. Here, the radio frame 1 may be transmitted in a multi-subcarrier based transmission scheme having a predefined subcarrier interval in the operating frequency band of the communication node. Here, a beam sweeping period 70 for beam sweeping may be configured in the subframe 10. The communication node may configure a beam sweeping region 80 during the beam sweeping period 70. Beam sweeping may be applied to all signals in the beam sweeping region 80. The beam sweeping region 80 may be allocated to a pre-defined time and frequency resource with a 5 ms periodicity in each of a forward link (DL) and a reverse link (UL).

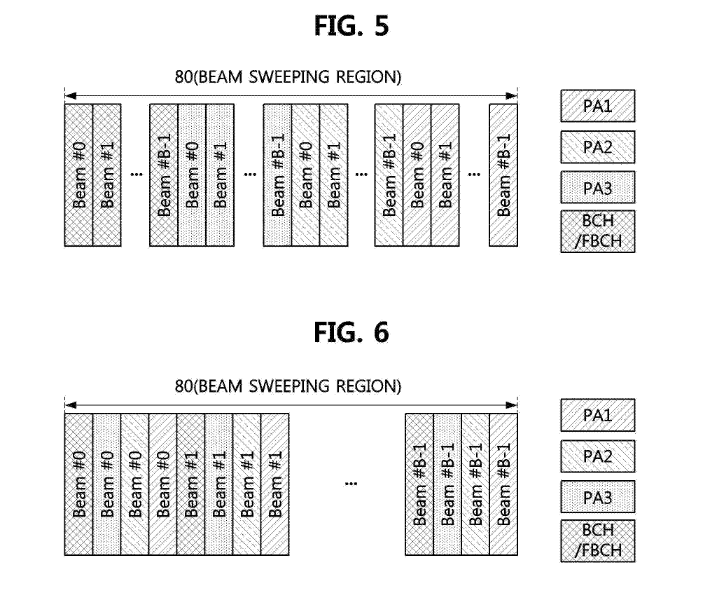

FIG. 5 is a diagram illustrating a method of transmitting a preamble, a broadcast channel, and a feedback channel in a beam sweeping region by applying time division multiplexing and a beam grouping scheme.

Referring to FIG. 5, a communication node may transmit a broadcast channel (BCH) or a feedback channel (FBCH) together with one or more preambles (PAs) in the beam sweeping region 80 of the radio frame 1. That is, the communication node may arrange one or more PAs and a BCH in the beam sweeping region 80 and transmit the radio frame 1 in which the beam sweeping region 80 is configured. Also, the communication node may arrange one or more PAs and a FBCH in the beam sweeping region 80 and may transmit the radio frame 1 in which the beam sweeping region 80 is configured.

Here, the communication node may transmit the BCH or the FBCH together with the PAs by applying time division multiplexing (TDM). Here, the communication node may transmit the BCH or the FBCH together with the PAs as included in the beam sweeping region 80 of the radio frame 1. Also, the communication node may transmit other PAs or channels through the beam sweeping region 80 as well as the PAs, and the BCH or the FBCH.

Specifically, the communication node may transmit the BCH or the FBCH together with the PAs by applying TDM and the beam grouping scheme. That is, the communication node may transmit each of PAs and BCH (or FBCH) through a plurality of beams by grouping the plurality of beams.

For example, in a case that three PAs (i.e., PA1 to PA3) are transmitted, the communication node may use beams #0, #1, . . . , and #(B-1) to transmit the PA1, beams #0, #1, . . . , and #(B-1) to transmit the PA2, and beams #01, #1, . . . , and #(B-1) to transmit the PA3. Also, the communication may use the beams #0, #1, . . . , and #(B-1) to transmit the BCH or the FBCH.

FIG. 6 is a diagram illustrating a method of transmitting a preamble, a broadcast channel, and a feedback channel in a beam sweeping region by applying time division multiplexing and an information grouping scheme.

Referring to FIG. 6, a communication node may transmit at least one of BCH and FBCH together with at least one PA by applying FDM or TDM.

Specifically, the communication node may transmit a BCH or FBCH together with at least one PA by applying TDM and the information grouping scheme. That is, the communication node may arrange a BCH or a FBCH together with at least one PA in the beam sweeping region 80, and transmit the BCH (or FBCH) and the at least one PA through a single beam by grouping the BCH (or FBCH) and the at least one PA for the single beam.

For example, the communication node may use a beam #0 to transmit the BCH or the FBCH together with a first preamble PA1, a second preamble PA2, and a third preamble PA3. Also, the communication node may use a beam #1 to transmit the BCH or the FBCH together with the PA1, the PA2, and the PA3. Also, the communication node may use a beam #2 to transmit the BCH or the FBCH together with the PA1, the PA2, and the PA3.

As described above, the communication may transmit the BCH or the FBCH together with the PA1, PA2, and PA3 by applying the information grouping scheme for different beams #0 to #(B-1).

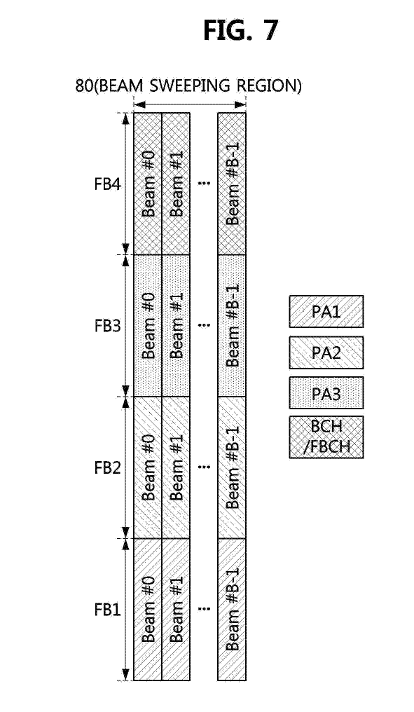

FIG. 7 is a diagram illustrating a method of transmitting a preamble, a broadcast channel, and a feedback channel in a beam sweeping region by applying frequency division multiplexing.

Referring to FIG. 7, the communication node may transmit a BCH or a FBCH together with one or more PAs in the beam sweeping region 80 of the radio frame 1 by applying the frequency division multiplexing (FDM).

For example, the communication node may transmit a first preamble PA1 using a first frequency band FB1 of the beam sweeping region 80. Also, the communication node may transmit a second preamble PA2 using a second frequency band FB2 of the beam sweeping region 80. Also, the communication node may transmit a third preamble PA3 using a third frequency band FB3 of the beam sweeping region 80. Also, the communication node may transmit the BCH or the FBCH using a fourth frequency band FB4 of the beam sweeping region 80. Here, the communication node may transmit different information (PA, BCH, FBCH) through each frequency band, and may use the same beam to transmit the BCH or the FBCH together with the PA1, the PA2, and the PA3 by using a same beam at the same time.

In FIGS. 5 to 7, a PA may be used for time and frequency synchronization between transmitting and receiving nodes and transmission of identification information of the transmitting node. Also, a BCH may be used for system information transmission for network connection. Also, a FBCH may be used for transmission of measurement information and the like for the preamble (PA). Also, beam training information for transmission beam training may be estimated implicitly using the PA, the BCH or the FBCH. Alternatively, the beam training information may be explicitly estimated using a separate PA transmitted for the transmission beam training. Here, the beam training information may refer to information (e.g., a beam index) capable of distinguishing or identifying each of a plurality of beams.

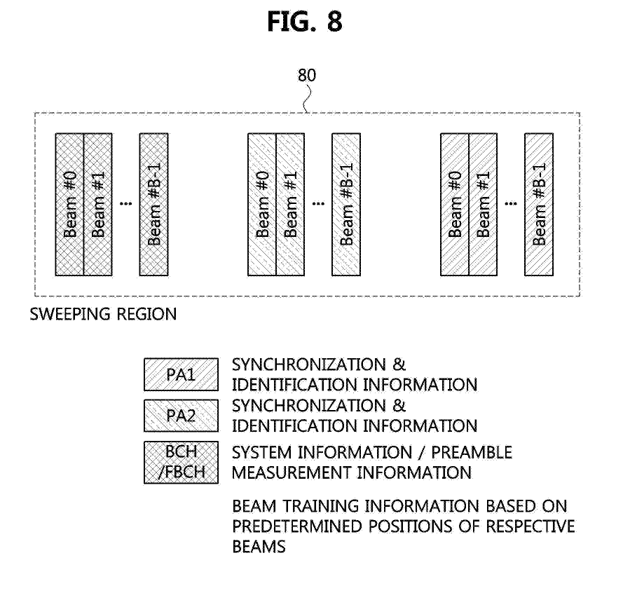

FIG. 8 is a diagram illustrating an example of a method of transmitting two preambles and one broadcast channel or feedback channel.

Referring to FIG. 8, a communication node may include one BCH or FBCH, and a plurality of PAs (e.g., two PAs) in the beam sweeping region 80 of the radio frame 1. Here, predefined transmission positions of respective beams for transmitting the BCH or the FBCH, and the two PAs (i.e., PA1 and PA2) may be configured. Here, the beam training information may be included in the BCH or the FBCH, and the PAs (i.e., PA1 and PA2).

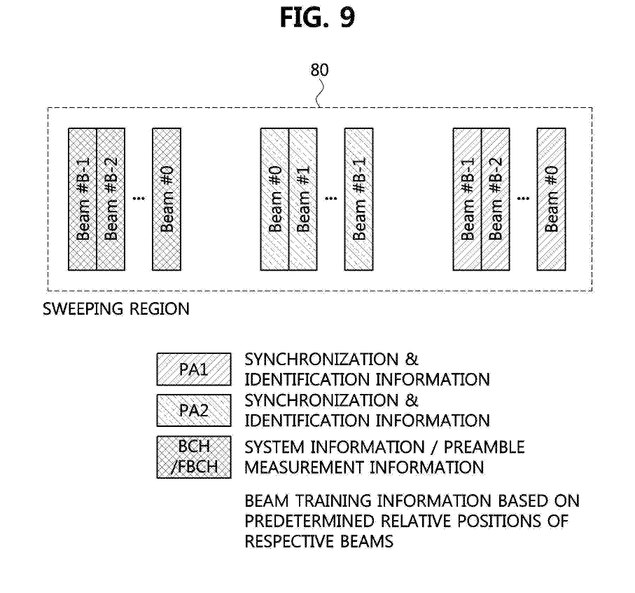

FIG. 9 is a diagram illustrating another example of a method of transmitting two preambles and one broadcast channel or feedback channel.

Referring to FIG. 9, a communication node may include one BCH or FBCH, and a plurality of PAs (e.g., two PAs) in the beam sweeping region 80 of the radio frame 1. Here, predefined relative transmission positions of respective beams for transmitting the BCH or the FBCH, and the two PAs (i.e., PA1 and PA2) may be configured. For example, the positions of beams for transmitting the PA1, and the BCH or the FBCH may be predefined in the order of beam #(B-1), . . . , and beam #0, and the positions of beams for transmitting the PA2 may be predefined in the order of beam #0, . . . , and beam #(B-1). Here, the beam training information may be included in the BCH or the FBCH, and the PAs (i.e., PA1 and PA2).

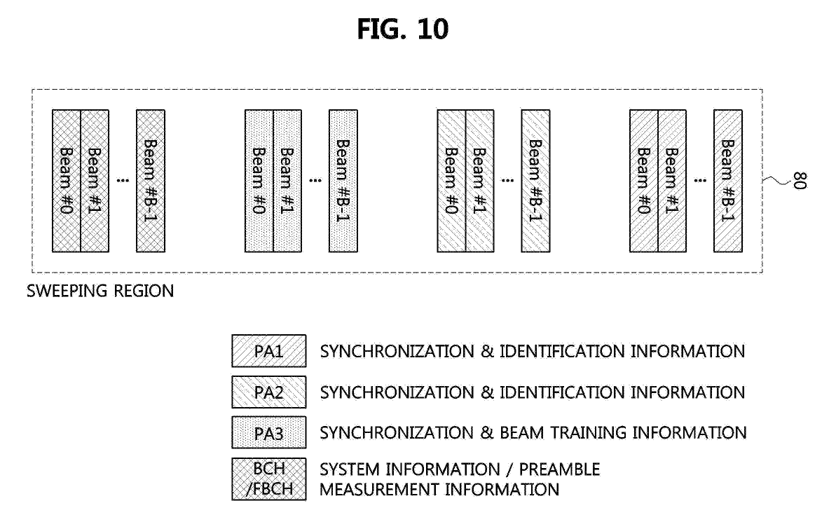

FIG. 10 is a diagram illustrating another example of a method of transmitting three preambles and one broadcast channel or feedback channel.

Referring to FIG. 10, a communication node may include one BCH or FBCH, and a plurality of PAs (e.g., three PAs) in the beam sweep region 80 of the radio frame 1. Here, in case that three PAs are transmitted, the communication node may include the beam training information in one of the three preambles PA1 to PA3.

For example, in case that three PAs (i.e., PA1 to PA3) are transmitted, the communication node may transmit each of the PAs (i.e., PA1 to PA3) by using a plurality of different beams. Also, the communication may transmit the BCH or the FBCH by using a plurality of different beams. Here, the communication node may transmit the radio frame 1 by including the beam training information in one of the PAs (i.e., PA1 to PA3).

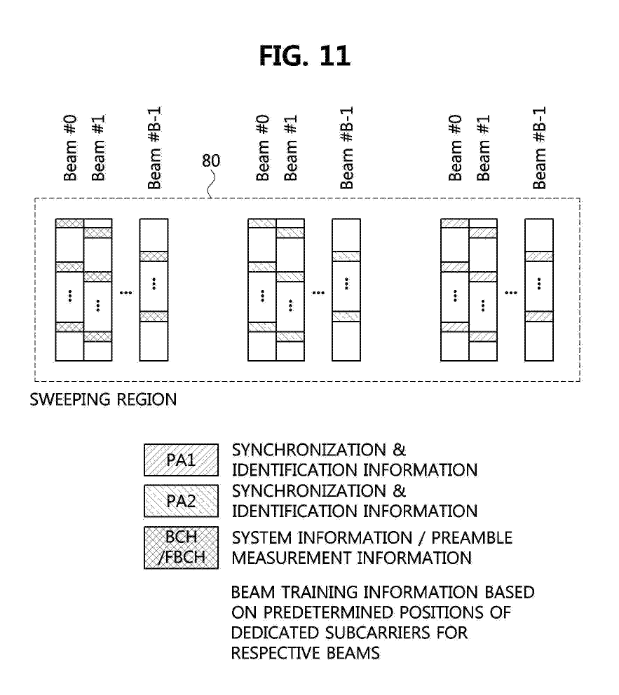

FIG. 11 is a diagram illustrating yet another example of a method of transmitting two preambles and one broadcast channel or feedback channel.

Referring to FIG. 11, a communication node may include one BCH or FBCH, and a plurality of PAs (e.g., two PAs) in the beam sweeping region 80 of the radio frame 1. Here, in case that two PAs (i.e., PA1 and PA2) are transmitted, predetermined positions of dedicated subcarriers for respective beams may be configured in the PAs (i.e., PA1 and PA2), and the BCH or the FBCH. Here, the beam training information may be included in the BCH or the FBCH, and the PAs PA1 and PA2.

For example, in case that two PAs (i.e., PA1 to PA2) are transmitted, the communication node may transmit each of the PA1 and the PA2 by using a plurality of different beams. Also, the communication node may transmit the BCH or the FBCH by using a plurality of different beams. Here, predefined positions of dedicated subcarriers for respective beams may be configured for the PA1 and the PA2, and the BCH or the FBCH. Here, the beam training information may be included in the BCH or the FBCH, and the PAs PA1 and PA2.

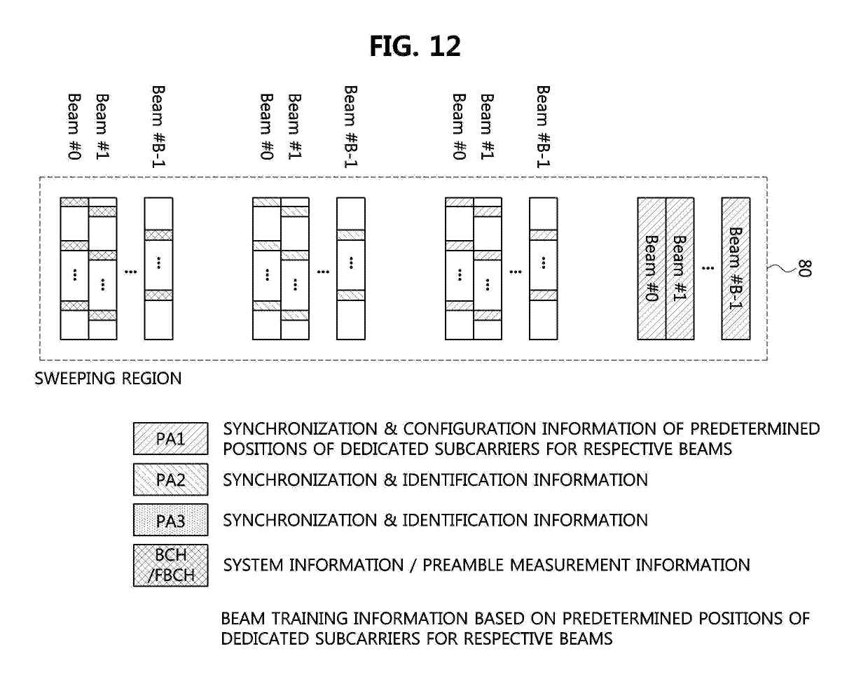

FIG. 12 is a diagram illustrating another example of a method of transmitting three preambles and one broadcast channel or feedback channel.

Referring to FIG. 12, a communication node may include one BCH or FBCH, and a plurality of PAs (e.g., three PAs) in the beam sweep region 80 of the radio frame 1. Here, in case that three PAs are transmitted, one of the three PAs may include configuration information of predetermined positions of dedicated subcarriers for respective beams through which the BCH or the FBCH, and the other two PAs are transmitted. Here, information for the beam training information may be included in the BCH or the FBCH, and the other two PAs.

For example, in case that three PAs (i.e., PA1 to PA3) are transmitted, the communication node may transmit each of the PAs (i.e., PA1 to PA3) by using a plurality of different beams. Also, the communication node may transmit the BCH or the FBCH by using a plurality of different beams. Here, the PA1 may include configuration information of predetermined positions of dedicated subcarriers for respective beams through which the BCH or the FBCH, and the other two PAs are transmitted. Here, the PA2 and PA3 may include the beam training information, and the BCH or the FBCH may also include the beam training information.

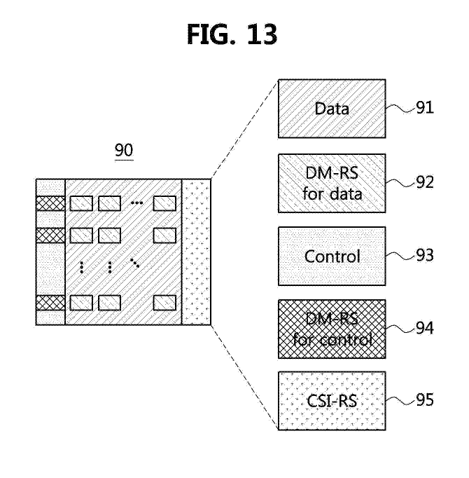

FIG. 13 is a diagram illustrating a structure of a slot included in a radio frame according to an example of the present disclosure.

Referring to FIG. 13, a radio frame 1 according to an embodiment of the present disclosure may include a plurality of subframes 10, and each of the plurality of subframes 10 may include a plurality of slots 90. Here, each slot 90 may be any of the long slot 20, the medium slot 30, or the short slot 40 shown in FIG. 3.

Each of the plurality of slots 90 may include a data region 91, demodulation reference signal (DM-RS) regions 92 and 94, a control region 93, and a channel state information reference signal (CSI-RS) region 95. The demodulation reference signal regions 92 and 94 may include a first demodulation reference signal (i.e., DM-RS for data) region 92 for demodulating signals mapped to the data region 91 and a second demodulation reference signal (i.e., DM-RS for control) region 94 for demodulating signals mapped to the control region 93.

The communication node may transmit a data channel by including the data channel in the data region 91 of the slot 90. Also, the communication node may transmit at least one of scheduling information, channel state information (CSI) feedback, hybrid automatic repeat request (HARD) feedback, and scheduling request information by including the at least one information in the control region 93 of the slot 90. Also, the communication node may transmit demodulation reference signals for channel estimation through the DM-RS regions 92 and 94. Also, the communication node may transmit CSI-RSs through the CSI-RS region 95. However, the CSI-RS region 95 may not necessarily include the CSI-RS, and the communication node may omit transmission of the CSI-RS. That is, the communication node may configure the slot 90 including the CSI-RS region 95, or may configure the slot 90 that does not include the CSI-RS region 95. Here, the communication node may transmit the data region 91 and the control region 93 together by applying the frequency division multiplexing scheme. Also, the communication node may transmit the data region 91 and the CSI-RS region 95 together by applying the frequency division multiplexing scheme.

The communication node may configure a DL slot interval by combining a slot having the CSI-RS region 95 and one or more slots that do not have the CSI-RS region 95. Also, the communication node configure a UL slot interval by combining a slot having the CSI-RS region 95 and one or more slots that do not have the CSI-RS region 95. That is, the communication node may necessarily include the data region 91, the DM-RS regions 92 and 94, and the control region 93 in each of the plurality of slots. The communication node may not include the CSI-RS region 95 in a specific slot among the plurality of slots. Here, the communication node may arrange the DL slot interval and the UL slot interval to be mutually symmetric.

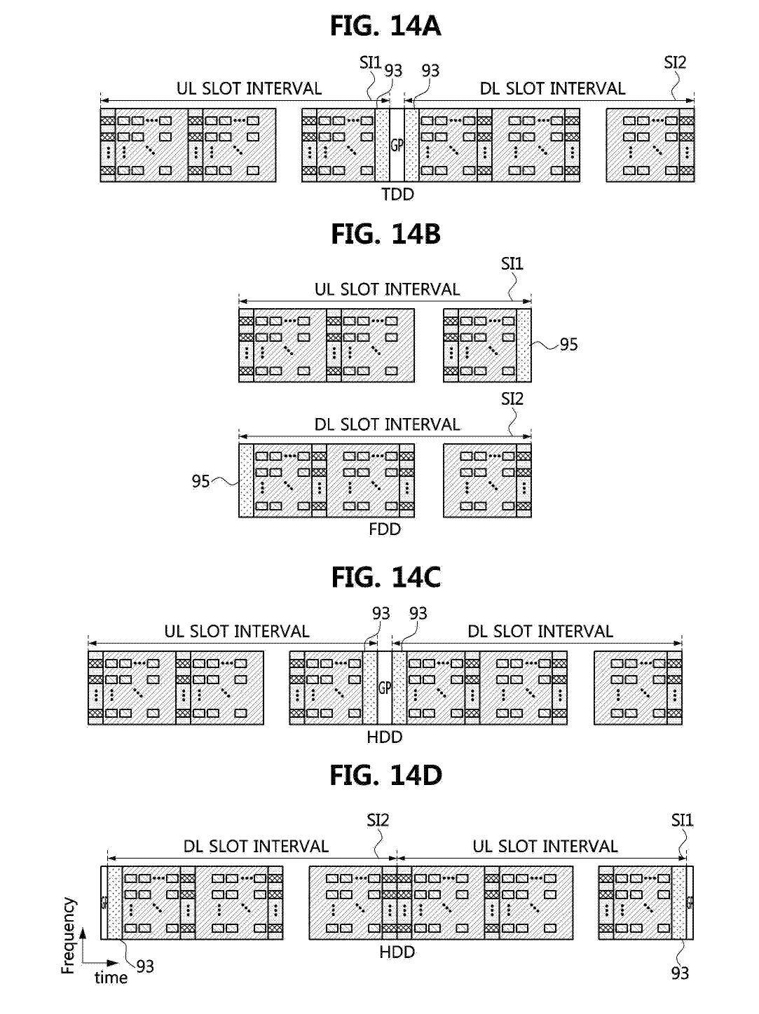

FIGS. 14A to 14D are diagrams illustrating DL slot intervals and UL slot intervals according to duplexing schemes.

Referring to FIGS. 14A to 14D, a communication node may configure a DL interval and a UL interval by applying a duplexing technique. For example, in FIG. 14A, the communication node may transmit and receive the radio frame 1 by applying a TDD scheme, and may configure a DL slot interval SI1 and a UL slot interval SI2. The communication node may include a CSI-RS region 95 in one slot (e.g., the last slot) of the SI1. Also, the communication node may include a CSI-RS region 95 in one slot (e.g., the first slot) of the SI2. Here, the communication node may arrange a guard interval GP having a first length between the SI1 and the SI2.

As another example, in FIG. 14B, the communication node may transmit and receive the radio frame 1 by applying a FDD scheme, and may configure a DL slot interval SI1 and a UL slot interval SI2. The communication node may include a CSI-RS region 95 in one slot (e.g., the last slot) of the SI1. Also, the communication node may include a CSI-RS region 95 in one slot (e.g., the first slot) in the SI2.

As yet another example, in FIG. 14C, the communication node may transmit and receive the radio frame 1 by applying a hybrid division duplexing (HDD) scheme, and may configure a DL slot interval SI1 and a UL slot interval SI2. The communication node may include a CSI-RS region 95 in one slot (e.g., the first slot or the last slot) of the SI1. Also, the communication node may include a CSI-RS region 95 in one slot (e.g., the first slot or the last slot) of the SI2. Here, the communication node may arrange a guard interval GP having a first length between the SI1 and the SI2.

As another example, in FIG. 14D, the communication node may arrange the GP at the front of the SI1 and arrange the GP at the rear of the SI2. Here, the GP may be arranged at the front end of the SI1 so as to have a shorter length than the GP applied to the TDD scheme shown in FIG. 14A. Also, the GP may be arranged at the rear end of the SI2 so as to have a shorter length than the GP applied to the TDD scheme shown in FIG. 14A.

Meanwhile, in the case of the TDD scheme, the communication node may not allocate the GP between the SI1 and the SI2, or arrange the GP having a second length shorter than the first length between the SI1 and the SI2. In case that the GP is not arranged or the GP is arranged to have the second length shorter than the first length, the communication node may operate in one of two operation modes.

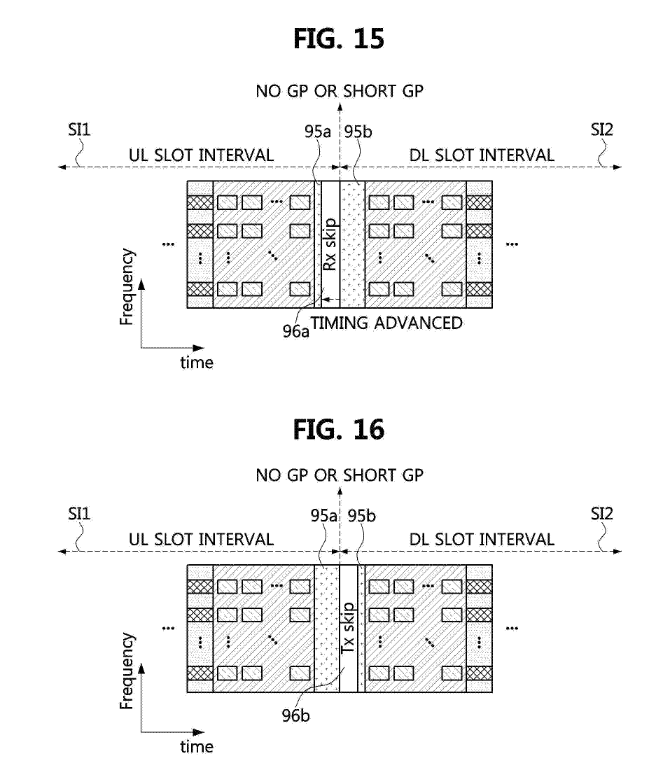

FIG. 15 is a diagram for explaining a first operation mode in case that insertion of a GP is omitted or a GP having a short length is inserted.

Referring to FIG. 15, in order to reduce overhead of the GP due to the transmission/reception mode switching in the frame structure of the TDD scheme, the communication node may not arrange the GP between the SI1 and the SI2, or may arrange the GP having the second length shorter than the first length. In this case, the communication node may operate in the first mode.

Specifically, in the DL slot interval SI1, the communication node may skip reception during a predetermined period corresponding to a round trip delay (RTD) between the transmitting and receiving communication nodes. For example, reception of a part (e.g. 96a) of the CSI-RS region 95a of the SI1 may be skipped. Also, the communication node may start transmission of the SI2 (i.e., timing advanced) ahead of time by the period 96a corresponding to the skipped reception in the SI1. That is, the communication node may skip a reception operation of the SI1 for a time corresponding to the RTD and advance a transmission start time of the SI2 by a time 96a corresponding to the RTD. Accordingly, it is possible to reduce the overhead of the GP due to the transmission/reception mode switching in the frame structure employing the TDD scheme.

FIG. 16 is a diagram for explaining a second operation mode in case that insertion of a GP is omitted or a GP having a short length is inserted.

Referring to FIG. 16, in order to reduce overhead of the GP due to the transmission/reception mode switching in the frame structure of the TDD scheme, the communication node may not arrange the GP between the SI1 and the SI2, or may arrange the GP having the second length shorter than the first length. In this case, the communication node may operate in the second mode.

Specifically, in the UL slot interval SI2, the communication node may skip transmission during a predetermined period corresponding to a RTD between the transmitting and receiving communication nodes. For example, transmission of a part (e.g., 96b) of the CSI-RS region 95b of the SI2 may be skipped. Accordingly, it is possible to reduce the overhead of the GP due to the transmission/reception mode switching in the frame structure employing the TDD scheme.

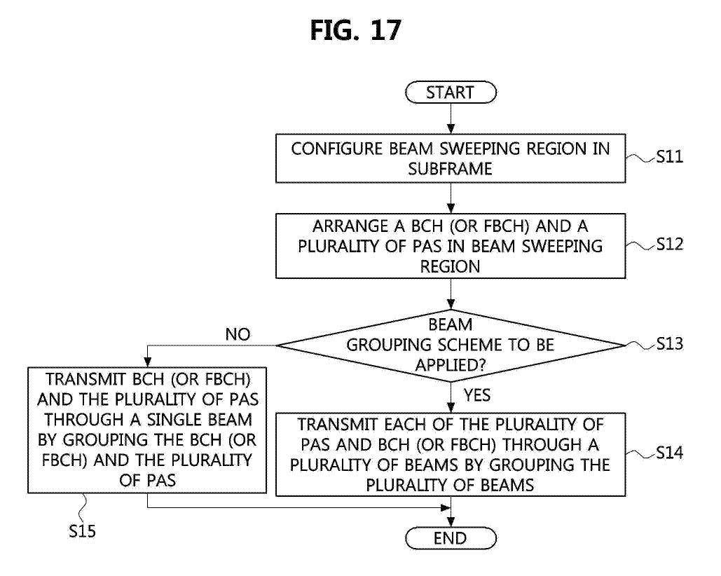

FIG. 17 is a flow chart for explaining an example of a method of transmitting a multi-subcarrier based radio frame according to an embodiment of the present disclosure.

Referring to FIG. 17, a communication node may configure at least one beam sweeping region for beam sweeping in a plurality of subframes 10 constituting the radio frame 1 (S11). Here, the communication node may configure the beam sweeping region in all the subframes 10 constituting the radio frame 1, or may configure the beam sweeping regions in some of the subframes 10.

Then, the communication node may arrange a BCH or a FBCH together with a plurality of PAs in the beam sweeping region (S12).

Then, the communication node may determine whether the beam grouping scheme is applied when transmitting the BCH or the FBCH together with the plurality of PAs (S13).

As a result of the step S13, if the beam grouping scheme is determined to be applied, the communication node may transmit each of the BCH (or FBCH) and the plurality of PAs using a plurality of beams by grouping the plurality of beams (S14). Here, the communication node may transmit each of the BCH (or FBCH) and the plurality of PAs using a plurality of beams in the TDM manner.

On the other hand, if it is determined in the step S13 that the beam grouping scheme is not applied, each of the plurality of PAs may be transmitted by applying the information grouping scheme. Also, the BCH (or FBCH) may be transmitted by applying the information grouping scheme (S15). Here, the communication node may transmit each of the plurality of PAs using a single beam in the TDM manner. Also, the communication node may transmit the BCH or the FBCH using a single beam in the TDM manner.

According to the embodiments of the present disclosure, provided are a method of transmitting radio frames for radio transmission of the 5G mobile communication system, and a communication node therefor. Also, provided are a method of transmitting radio frames, which is suitable for broadband wireless transmissions and beamforming techniques using massive antenna, and a communication node therefor.

According to the embodiments of the present disclosure, provided are a method of transmitting radio frames, which supports various transmission and reception duplexing schemes, and a communication node therefor. Also, provided are a method of transmitting radio frames, which supports various types of multi-subcarrier based wireless transmission schemes, and a communication node therefor. Also, provided are a method of transmitting radio frames of unified format, which supports radio transmissions in various networks, and a communication node therefor.

According to the embodiments of the present disclosure, provided are a method of transmitting radio frames, which supports beam sweeping operations and initial access operations based on beam sweeping, and a communication node therefor. Also, overhead due to the beam sweeping in the initial access operations can be reduced, and performance of beam searching can be enhanced. Also, overhead of guard periods due to transmission and reception mode switching in a frame structure to which the TDD scheme is applied can be reduced.

The embodiments of the present disclosure may be implemented as program instructions executable by a variety of computers and recorded on a computer readable medium. The computer readable medium may include a program instruction, a data file, a data structure, or a combination thereof. The program instructions recorded on the computer readable medium may be designed and configured specifically for the present disclosure or can be publicly known and available to those who are skilled in the field of computer software.

Examples of the computer readable medium may include a hardware device such as ROM, RAM, and flash memory, which are specifically configured to store and execute the program instructions. Examples of the program instructions include machine codes made by, for example, a compiler, as well as high-level language codes executable by a computer, using an interpreter. The above exemplary hardware device can be configured to operate as at least one software module in order to perform the embodiments of the present disclosure, and vice versa.

While the embodiments of the present disclosure and their advantages have been described in detail, it should be understood that various changes, substitutions and alterations may be made herein without departing from the scope of the present disclosure.

What is claimed is:

1. A multi-subcarrier based radio frame transmission method of a communication node in a mobile communication system, comprising:
configuring at least one beam sweeping region for beam sweeping in a plurality of subframes constituting a radio frame;
arranging a broadcast channel (BCH) or a feedback channel (FBCH) together with a plurality of preambles (PAs) in the at least one beam sweeping region; and
transmitting the radio frame in which the at least one beam sweeping region is configured.

2. The multi-subcarrier based radio frame transmission method according to claim 1, wherein, in the transmitting, the BCH or the FBCH is transmitted together with the plurality of PAs through a plurality of beams in a time division multiplexing (TDM) scheme by grouping the plurality of beams.

3. The multi-subcarrier based radio frame transmission method according to claim 1, wherein, in the transmitting, the BCH or the FBCH is transmitted together with the plurality of PAs through a same beam in a time division multiplexing (TDM) scheme by grouping the BCH or the FBCH together with the plurality of PAs.

4. The multi-subcarrier based radio frame transmission method according to claim 1, wherein, in the transmitting, the BCH or the FBCH is transmitted together with the plurality of PAs by using different frequency bands in a frequency division multiplexing (FDM) scheme, transmitted together with the plurality of PAs by using a first beam at a first time, and transmitted together with the plurality of PAs by using a second beam at a second time.

5. The multi-subcarrier based radio frame transmission method according to claim 1, wherein at least one of the plurality of PAs includes at least one beam index for identifying a plurality of beams for the beam sweeping.

6. The multi-subcarrier based radio frame transmission method according to claim 1, wherein each of the plurality of subframes includes a plurality of slots, and the plurality of slots are 2ⁿ slots, 2×2ⁿ slots, or 7×2ⁿ slots wherein n is a natural number.

7. The multi-subcarrier based radio frame transmission method according to claim 6, wherein each of the 2ⁿ slots includes 14 symbols, each of the 2×2ⁿ slots includes 7 symbols, or each of the 7×2ⁿ slots includes 2 symbols.

8. The multi-subcarrier based radio frame transmission method according to claim 6, wherein one of the plurality of slots includes a control region, a data region, a demodulation reference signal (DM-RS) region, and a channel state information reference signal (CSI-RS) region, and the one of the plurality of slots is arranged in a forward link slot interval or a reverse link slot interval.

9. The multi-subcarrier based radio frame transmission method according to claim 8, wherein a first guard interval, a second guard interval shorter than the first guard interval, or no guard interval is arranged between the forward link slot interval and the reverse link slot interval.

10. The multi-subcarrier based radio frame transmission method according to claim 9, wherein, when the second guard interval shorter than the first guard interval, or no guard interval is arranged between the forward link slot interval and the reverse link slot interval, a transmission start time of the reverse link slot interval is advanced by a time corresponding to a round trip delay (RTD).

11. A communication node in a mobile communication system, for transmitting a multi-subcarrier based radio frame, comprising a processor, a memory storing at least one instruction executed by the processor, and a transceiver performing communications as connected to the mobile communication system, wherein the at least one instruction is configured to:
configure at least one beam sweeping region for beam sweeping in a plurality of subframes constituting a radio frame;
arrange a broadcast channel (BCH) or a feedback channel (FBCH) together with a plurality of preambles (PAs) in the at least one beam sweeping region; and
transmit the radio frame in which the at least one beam sweeping region is configured.

12. A communication node in a mobile communication system according to claim 11, wherein the at least one instruction is further configured to transmit the BCH or the FBCH together with the plurality of PAs through a plurality of beams in a time division multiplexing (TDM) scheme by grouping the plurality of beams.

13. A communication node in a mobile communication system according to claim 11, wherein the at least one instruction is further configured to transmit the BCH or the FBCH together with the plurality of PAs through a same beam in a time division multiplexing (TDM) scheme by grouping the BCH or the FBCH together with the plurality of PAs.

14. A communication node in a mobile communication system according to claim 11, wherein the at least one instruction is further configured to transmit the BCH or the FBCH together with the plurality of PAs by using different frequency bands in a frequency division multiplexing (FDM) scheme, transmit the BCH or the FBCH together with the plurality of PAs by using a first beam at a first time, and transmit the BCH or the FBCH together with the plurality of PAs by using a second beam at a second time.

15. A communication node in a mobile communication system according to claim 11, wherein at least one of the plurality of PAs includes at least one beam index for identifying a plurality of beams for the beam sweeping.

16. A communication node in a mobile communication system according to claim 11, wherein each of the plurality of subframes includes a plurality of slots, and the plurality of slots are 2ⁿ slots, 2×2ⁿ slots, or 7×2ⁿ slots wherein n is a natural number.

17. A communication node in a mobile communication system according to claim 16, wherein each of the 2ⁿ slots includes 14 symbols, each of the 2×2ⁿ slots includes 7 symbols, or each of the 7×2ⁿ slots includes 2 symbols.

18. A communication node in a mobile communication system according to claim 16, wherein one of the plurality of slots includes a control region, a data region, a demodulation reference signal (DM-RS) region, and a channel state information reference signal (CSI-RS) region, and the one of the plurality of slots is arranged in a forward link slot interval or a reverse link slot interval.

19. A communication node in a mobile communication system according to claim 18, wherein a first guard interval, a second guard interval shorter than the first guard interval, or no guard interval is arranged between the forward link slot interval and the reverse link slot interval.

20. A communication node in a mobile communication system according to claim 19, wherein, when the second guard interval shorter than the first guard interval, or no guard interval is arranged between the forward link slot interval and the reverse link slot interval, a transmission start time of the reverse link slot interval is advanced by a time corresponding to a round trip delay (RTD).
